(19) United States
(12) Patent Application Publication
(10) Pub. No.: US 2014/0128241 A1
(43) Pub. Date: May 8, 2014

(54) GLASS-CERAMICS AND METHODS OF MAKING THE SAME

(71) Applicants: Anatoly Z. Rosenflanz, Maplewood, MN (US); Jean A. Tangeman, Minneapolis, MN (US)

(72) Inventors: Anatoly Z. Rosenflanz, Maplewood, MN (US); Jean A. Tangeman, Minneapolis, MN (US)

(73) Assignee: 3M INNOVATIVE PROPERTIES COMPANY, St. Paul, MN (US)

(21) Appl. No.: 14/126,728

(22) PCT Filed: Jun. 22, 2012
(86) PCT No.: PCT/US2012/043671

§ 371 Date: Dec. 16, 2013

Related U.S. Application Data
(60) Provisional application No. 61/502,172, filed on Jun. 28, 2011.

(51) Int. Cl. C03C 10/00; C03B 32/02

(52) U.S. Cl. CPC C03C 10/0036; C03B 32/02; C03C 10/00
USPC 501/32; 65/33.1

(57) ABSTRACT

Glass-ceramics comprising Al₂O₃ and rare earth oxide, yttrium oxide, and/or alkaline earth oxide. Uses of the glass-ceramics include dental articles, orthodontic appliances, abrasive particles, cutting tools, infrared windows, and ceramic bearings.

### CROSS REFERENCE TO RELATED APPLICATION

This application claims the benefit of U.S. Provisional Patent Application No. 61/502,172, filed Jun. 28, 2011, the disclosure of which is incorporated by reference herein in its entirety.

### BACKGROUND

Although performance and durability are highly desirable characteristics for dental replacement and repair work, for example, they alone are not the sole concern for practitioners and patients. Aesthetic value, or how dental materials and articles and orthodontic appliances look inside the mouth is just as desirable.

For example, in prosthodontics and restorative dentistry, where tooth replacement or prostheses are custom made to fit in or on a tooth structure, there are instances where the restoration or repair can be seen from a short distance when the mouth is open. Thus in those instances, it would be highly desired that the dental material be nearly indistinguishable from adjacent tooth structure.

Prosthetics and restorative dentistry encompass the fabrication and installation of, for example, restoratives, replacements, inlays, onlays, veneers, full and partial crowns, bridges, implants, and posts. Conventional materials used to make dental prostheses include gold, ceramics, amalgam, porcelain, and composites. In terms of aesthetic value, it is perceived that porcelains, composites, and ceramics look better than amalgam and metals, since a prosthetic made from those nonmetals better matches or blends in with the color of adjacent natural teeth.

For orthodontic appliances (typically, brackets, which are small slotted bodies for holding a curved arch wire, and associated tooth bands if banded attachment is used), stainless steel is an ideal material because it is strong, nonabsorbent, weldable, and relatively easy to form and machine. A significant drawback of metal appliances, however, relates to cosmetic appearance when the patient smiles. Adults and older children undergoing orthodontic treatment are often embarrassed by the “metallic smile” appearance of metal bands and brackets, and this problem has led to various improvements in recent years.

One area of improvement involves use of nonmetal materials. Both plastic and ceramic materials present an improved appearance in the mouth, and often the only significantly visible metal components are thin arch wires that are cosmetically acceptable. Plastic is not an ideal material because it lacks the structural strength of metal, and is susceptible to staining and other problems. Ceramics such as sapphire or other transparent crystalline materials have undesirable prismatic effects. Also, single crystal aluminum oxide appliances are subject to cleavage under the loads that occur in the course of orthodontic treatment. Other ceramics have been largely opaque so that they either do not match tooth color or require coloring.

Glasses and glass-ceramics have also been used for dental replacement and repair work. Glass-ceramics based on lithium disilicate utilized in production of shaped dental products are known. For example, some compositions are based on SiO₂ (57-80 wt-%) and Li₂O (11-19 wt-%) with minor amounts of Al₂O₃, La₂O₃, MgO, ZnO, K₂O, P₂O₅ and other materials. Other examples are moldable ceramic-glass compositions which include 50-99 parts by weight of alumina and/or zirconia powder and 1 to 50 parts by weight of glass powder.

Digitized machining of ceramics (commonly known as CAD/CAM milling) is one method for producing useful dental shapes. However, the machining of fully densified structural ceramics like Al₂O₃ and ZrO₂ into complex dental geometries is difficult due to rapid tool wear. For this reason, methods involving machining of a green ceramic body have been developed (e.g., available, for example, under the trade designation “LAVA” from 3M Company, St. Paul, Minn.).

### SUMMARY

In one aspect, the present disclosure describes a first glass-ceramic comprising at least 20 (in some embodiments, at least 25, 30, 35, 40, 45, 50, or even at least 55; in some embodiments, in a range from 20 to 60, 25 to 60, 30 to 60, 35 to 60, 40 to 60; or even 25 to 45) percent by weight alumina and at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight collectively of rare earth oxide, yttrium oxide, and alkaline earth oxide (including in some embodiments (a) zero alkaline earth oxide and at least 15 percent by weight collectively rare earth oxide and yttrium oxide (understood to mean in some embodiments there may be at least 15 percent by weight rare earth oxide and zero yttrium oxide and vice versa); or (b) at least 15 percent alkaline earth oxide and zero collectively rare earth oxide and yttrium oxide), based on the total weight of the glass-ceramic, wherein the rare earth is selected from the group consisting of La, Ce, Pr, Nd, Sm, Eu, Gd, and combinations thereof, wherein the alkaline earth oxide is selected from the group consisting of BaO, CaO, SrO, MgO, and combinations thereof, wherein the molar ratio of the alumina to the collective rare earth oxide, yttrium oxide, and alkaline earth oxide is up to 3.2 (in some embodiments, up to 3.1, 3, 2.9, 2.8, 2.7, 2.6, 2.5, 2.4, or even up to 2.3; in some embodiments, in a range from 1 to 3.2, 1.2 to 3.2, 1.5 to 3.2, 2 to 3, or even 2.3 to 2.9), and wherein the glass-ceramic has an average hardness in a range from 8 GPa to 12 GPa (in some embodiments, 8 GPa to 11 GPa) and an average flexural strength of at least 500 MPa (in some embodiments, at least in 550 MPa, 600 MPa, 650 MPa, 700 MPa, 750 MPa, 1 GPa, 1.25 GPa, 1.5 GPa, 1.75 GPa, 2 GPa, 2.25 GPa, or even at least 2.5 GPa). In some embodiments, for the first glass-ceramic at least a portion of the alumina and rare earth oxide are present as at least 20 (in some embodiments, at least 25, 30, 35, 40, 45, 50, or even at least 55; in some embodiments, in a range from 20 to 60, 30 to 60, or even 40 to 60) percent by volume of ReAlO₃, based on the total volume of the glass-ceramic, wherein Re is selected from the group consisting of La, Ce, Pr, Nd, Sm, Eu, Gd, and combinations thereof.

In another aspect, the present disclosure describes a second glass-ceramic comprising at least 20 (in some embodiments, at least 25, 30, 35, 40, 45, 50, or even at least 55; in some embodiments, in a range from 20 to 60, 25 to 60, 30 to 60, 35 to 60, 40 to 60; or even 25 to 45) percent by weight alumina and at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight rare earth oxide, based on the total weight of the glass-ceramic, wherein the rare earth is selected from the group consisting of La, Ce, Pr, Nd, Sm, Eu, Gd, and combinations thereof, wherein the molar ratio of alumina to rare earth oxide is up to 3.2 (in some embodiments, up to 3.1, 3, 2.9, 2.8, 2.7, 2.6, 2.5, 2.4, or even up to 2.3; in some embodiments, in a range from 2 to 3.2, 2 to 3, or even 2.3 to 2.9), wherein at least a portion of the alumina and rare earth oxide are present as at least 30 (in some embodiments, at least 35, 40, 45, 50, or even at least 55; in some embodiments, in a range from 30 to 60, 35 to 60, or even 40 to 60) percent by volume of ReAlO₃, wherein Re is selected from the group consisting of La, Ce, Pr, Nd, Sm, Eu, Gd, and combinations thereof, and wherein the glass-ceramic has an average flexural strength of at least 1.5 GPa (at least in some embodiments at least 1.75 GPa, 2 GPa, 2.25 GPa, or even at least 2.5 GPa). In some embodiments, the second glass-ceramic has an average hardness in a range from 8 GPa to 12 GPa (in some embodiments, 8 GPa to 11 GPa). In some embodiments, the glass-ceramic further comprises alkaline earth oxide selected from the group consisting of BaO, CaO, SrO, MgO, and combinations thereof, for example, up to 15 percent by weight.

In some embodiments, glass-ceramics described herein are optically translucent.

In this application:

“amorphous material” refers to material derived from a melt and/or a vapor phase that lacks any long range crystal structure as determined by x-ray diffraction and/or has an exothermic peak corresponding to the crystallization of the amorphous material as determined by a DTA (differential thermal analysis) as determined by the test described herein entitled “Differential Thermal Analysis”;

“ceramic” includes amorphous material, glass, crystalline ceramic, glass-ceramic, and combinations thereof;

“complex metal oxide” refers to a metal oxide comprising two or more different metal elements and oxygen (e.g., CeAl₁₁O₁₈ and Dy₃Al₅O₁₂, and Y₃Al₅O₁₂);

“complex Al₂O₃.metal oxide” refers to a complex metal oxide comprising, on a theoretical oxide basis, Al₂O₃ and one or more metal elements other than Al (e.g., CeAl₁₁O₁₈, Dy₃Al₅O₁₂, and MgA₁₂O₄);

“complex Al₂O₃.REO” refers to a complex metal oxide comprising, on a theoretical oxide basis, Al₂O₃ and rare earth oxide (e.g., CeAl₁₁O₁₈ and Dy₃Al₅O₁₂);

“dental article” refers to a restored dentition or a portion thereof. Examples include restoratives, replacements, inlays, onlays, veneers, full and partial crowns, bridges, implants, implant abutments, copings, anterior fillings, posterior fillings, cavity liners, sealants, dentures, posts, and bridge frameworks;

“dental material” refers to a dental composition such as a paste which when hardens forms a dental article;

“glass” refers to amorphous material exhibiting a glass transition temperature;

“glass-ceramic” refers to ceramics comprising crystals formed by heat-treating amorphous material;

“optically translucent” refers to materials exhibiting at least 20% total transmission through 0.8 mm thick sample when measured as described in Example 1;

“orthodontic appliance” refers to any device intended for mounting on a tooth, and used to transmit to the tooth corrective force from an arch wire, spring, elastic, or other force-applying component. Examples include brackets, buccal tubes, cleats, and buttons;

“prosthesis” includes crowns, bridges, inlays, onlays, veneers, copings, frameworks, and abutments;

“rare earth oxides” refers to cerium oxide (e.g., CeO₂), dysprosium oxide (e.g., Dy₂O₃), erbium oxide (e.g., Er₂O₃), europium oxide (e.g., Eu₂O₃), gadolinium (e.g., Gd₂O₃), holmium oxide (e.g., Ho₂O₃), lanthanum oxide (e.g., La₂O₃), lutetium oxide (e.g., Lu₂O₃), neodymium oxide (e.g., Nd₂O₃), praseodymium oxide (e.g., Pr₆O₁₁), samarium oxide (e.g., Sm₂O₃), terbium (e.g., Tb₂O₃), thorium oxide (e.g., Th₄O₇), thulium (e.g., Tm₂O₃), and ytterbium oxide (e.g., Yb₂O₃), and combinations thereof;

“REO” refers to rare earth oxide(s);

“restoratives” includes veneers, crowns, inlays, onlays, and bridge structures;

“T_{g}” refers to the glass transition temperature as determined by the test described herein entitled “Differential Thermal Analysis”; and

“Tₓ” refers to the crystallization temperature as determined by the test described herein entitled “Differential Thermal Analysis”.

Further, it is understood herein that unless it is stated that a metal oxide (e.g., Al₂O₃, complex Al₂O₃.metal oxide, etc.) is crystalline, for example, in a glass-ceramic, it may be amorphous, crystalline, or portions amorphous, and portions crystalline. For example, if a glass-ceramic comprises Al₂O₃ and ZrO₂, the Al₂O₃ and ZrO₂ may each be in an amorphous state, crystalline state, or portions in an amorphous state and portions in a crystalline state, or even as a reaction product with another metal oxide(s) (e.g., unless it is stated that, for example, Al₂O₃ is present as crystalline Al₂O₃ or a specific crystalline phase of Al₂O₃ (e.g., alpha Al₂O₃), it may be present as crystalline Al₂O₃ and/or as part of one or more crystalline complex Al₂O₃.metal oxides).

Further, it is understood that glass-ceramics formed by heating amorphous material not exhibiting a T_{g} may not actually comprise glass, but rather may comprise the crystals and amorphous material that does not exhibiting a T_{g}.

Uses of glass-ceramics described herein include being a dental article (e.g., restoratives, replacements, inlays, onlays, veneers, full and partial crowns, bridges, implants, implant abutments, copings, anterior fillings, posterior fillings, and cavity liner, and bridge frameworks) or an orthodontic appliance (e.g., brackets, buccal tubes, cleats, and buttons), abrasive particles, cutting tools, components (e.g., liners, pins, etc.) for bead mills, armor (both transparent and opaque), infrared windows, and ceramic bearings. The glass-ceramics can also be used, for example, in dental materials (e.g., dental restoratives, dental adhesives, dental filler, dental mill blanks, dental prosthesis, dental casing materials, and dental coatings) comprising a mixture of a hardenable resin and glass-ceramics described herein.

### DETAILED DESCRIPTION

In some embodiments, glass-ceramics described herein have an average grain size less than 250 nm, 200 nm, 150 nm, or even less than 100 nm.

In some embodiments, glass-ceramics described herein comprise at least a portion of the alumina and rare earth oxide are present as at least 20 (in some embodiments, at least 25, 30, 35, 40, 45, 50, or even at least 55; in some embodiments, in a range from 20 to 60, 30 to 60, or even 40 to 60) percent by volume of ReAlO₃, based on the total volume of the glass-ceramics, wherein Re is selected from the group consisting of La, Ce, Pr, Nd, Sm, Eu, Gd, and combinations thereof.

In some embodiments, glass-ceramics described herein further comprise at least 5 (in some embodiments, at least 10) percent by weight collectively zirconia and hafnia (understood to mean in some embodiments there may be at least 5 percent by weight zirconia and vice versa), based on the total weight of the glass-ceramic, wherein the molar ratio of alumina to collectively rare earth oxide yttrium oxide, and alkaline earth oxide (understood to the extent, if at all, such oxides are present is up to 3. In some embodiments, glass-ceramics described herein collectively comprise at least 80 (in some embodiments, at least 85, or even at least 90) percent of alumina, collectively rare earth oxide and yttrium oxide, and alkaline earth oxide selected from the group consisting of BaO, CaO, SrO, MgO, and combinations thereof, and at least one of zirconia or hafnia, based on the total weight of the glass-ceramic (understood to the extent, if at all, such oxides are present).

In some embodiments, glass-ceramics described herein collectively comprises at least 60 (in some embodiments, at least 65, or even at least 70) percent of alumina, collectively rare earth oxide and yttrium oxide, and alkaline earth oxide selected from the group consisting of BaO, CaO, SrO, MgO, and combinations thereof, based on the total weight of the glass-ceramic (understood to the extent, if at all, such oxides are present).

In some embodiments, glass-ceramics described herein contain no more than 20 (in some embodiments, not more than 15, 10, or even not more than 5) percent by weight collectively boria (B₂O₃), germanium oxide (GeO₂), phosphorus oxide (P₂O₅), silica (SiO₂), tellurium oxide (TeO₂), and vanadium oxide (V₂O₅), based on the total weight of the glass-ceramic. In some embodiments, glass-ceramics described herein contain no more than 20 (in some embodiments, not more than 15, 10, or even not more than 5) percent by weight silica, based on the total weight of the glass-ceramic.

In some embodiments, glass-ceramics described herein further comprise at least one of niobium oxide, tantalum oxide, titanium oxide, lithium oxide, potassium oxide, or sodium oxide (in some embodiments, up to 5, 10, 15, or even up to 20 percent by weight collectively of niobium oxide, tantalum oxide, titanium oxide, lithium oxide, potassium oxide, and sodium oxide, based on the total weight of the glass-ceramic (understood to the extent, if at all, such oxides are present)).

In some embodiments, glass-ceramics described herein further comprise at least one of ytterbium oxide or erbium oxide (in some embodiments, up to 5, 10, 15, or even up to 20 percent by weight collectively ytterbium oxide or erbium oxide, based on the total weight of the glass-ceramic (understood to the extent, if at all, such oxides are present)).

Some advantages of using glass-ceramics described herein for dental and orthodontic applications include improved processing abilities of complex-shaped articles combined with excellent material properties that are akin to those of structural ceramics (e.g., Al₂O₃ and ZrO₂). These useful dental shapes can be generated by either glass-like viscous flow or by machining blanks in amorphous or partially crystalline states.

Embodiments of glass-ceramics herein are made by heat-treating amorphous (including glass) comprising having any of the variety of composition described herein for the glass-ceramics.

Amorphous materials (e.g., glasses), ceramics comprising the amorphous material, particles comprising the amorphous material, etc. can be made, for example, by heating (including in a flame) the appropriate metal oxide sources to form a melt, desirably a homogenous melt, and then rapidly cooling the melt to provide amorphous material. The metal oxide sources and other additives can be in any form suitable to the process and equipment used to make the glasses or glass-ceramics. Desirable cooling rates include those of 10K/s and greater. Embodiments of amorphous materials can be made, for example, by melting the metal oxide sources in any suitable furnace (e.g., an inductive heated furnace, a gas-fired furnace, or an electrical furnace), or, for example, in a plasma. The resulting melt is cooled (e.g., discharging the melt into a cooling media (e.g., high velocity air jets, liquids, metal plates (including chilled metal plates), metal rolls (including chilled metal rolls), metal balls (including chilled metal balls), and the like)).

Further, other techniques for making melts and glasses, and otherwise forming amorphous material include vapor phase quenching, melt-extraction, plasma spraying, and gas or centrifugal atomization. For additional details regarding plasma spraying, see, for example, U.S. Pat. No. 7,179,526 (Rosenflanz et al.), the disclosure of which is incorporated herein by reference.

Gas atomization involves melting feed particles to convert them to melt. A thin stream of such melt is atomized through contact with a disruptive air jet (i.e., the stream is divided into fine droplets). The resulting substantially discrete, generally ellipsoidal amorphous material comprising particles (e.g., beads) are then recovered. Examples of bead sizes include those having a diameter in a range of about 5 micrometers to about 3 mm. Melt-extraction can be carried out, for example, as disclosed in U.S. Pat. No. 5,605,870 (Strom-Olsen), the disclosure of which is incorporated herein by reference. Containerless glass forming techniques utilizing laser beam heating as disclosed, for example, in U.S. Pat. No. 6,482,758 (Weber et al.), the disclosure of which is incorporated herein by reference, may also be useful in making glasses, glass-ceramics and amorphous materials.

Embodiments of amorphous material can be made utilizing flame fusion as disclosed, for example, in U.S. Pat. No. 6,254,981 (Castle), the disclosure of which is incorporated herein by reference. In this method, the metal oxide sources materials are fed (e.g., in the form of particles, sometimes referred to as “feed particles”) directly into a burner (e.g., a methane-air burner, an acetylene-oxygen burner, a hydrogen-oxygen burner, and like), and then quenched, for example, in water, cooling oil, air, or the like. Feed particles can be formed, for example, by grinding, agglomerating (e.g., spray-drying), melting, or sintering the metal oxide sources. The size of feed particles fed into the flame generally determines the size of the resulting amorphous material comprising particles.

Embodiments of amorphous materials can also be obtained by other techniques, such as: laser spin melt with free fall cooling, Taylor wire technique, plasmatron technique, hammer and anvil technique, centrifugal quenching, air gun splat cooling, single roller and twin roller quenching, roller-plate quenching and pendant drop melt extraction (see, e.g., Rapid Solidification of Ceramics, Brockway et al., Metals And Ceramics Information Center, A Department of Defense Information Analysis Center, Columbus, Ohio, January, 1984, the disclosure of which is incorporated here as a reference). Embodiments of amorphous materials may also be obtained by other techniques, such as: thermal (including flame or laser or plasma-assisted) pyrolysis of suitable precursors, physical vapor synthesis (PVS) of metal precursors and mechanochemical processing.

The cooling rate is believed to affect the properties of the quenched amorphous material. For instance, glass transition temperature, density, and other properties of glass typically change with cooling rates.

Rapid cooling may also be conducted under controlled atmospheres, such as a reducing, neutral, or oxidizing environment to maintain and/or influence the desired oxidation states, etc. during cooling.

The atmosphere can also influence amorphous material formation by influencing crystallization kinetics from undercooled liquid. For example, larger undercooling of alumina melts without crystallization has been reported in argon atmosphere as compared to that in air.

Amorphous materials can also be made by a sol-gel process. The sol-gel process comprises the steps of forming a precursor composition in the form of a dispersion, sol, or solution in an aqueous or organic liquid medium. The precursor composition can be processed into a variety of useful forms including coatings, films, powders, gels, aerogels, dense bulk shapes, fibers, flakes, and granules. Further details of these processes can be found in Sol-Gel Science by C. Jeffrey Brinker and George W. Scherer (Academic Press, 1990), the disclosure of which is incorporated herein by reference. Another method of making powders is by the spray pyrolysis of a precursor containing one or more glycolato polymetallooxanes dissolved in a volatile organic solvent; details about this process can be found in U.S. Pat. No. 5,958,361 (Laine et al.), the disclosure of which is incorporated herein by reference.

Useful amorphous material formulations include those at or near a eutectic composition(s) (e.g., binary and ternary eutectic compositions). In addition to compositions disclosed herein, other compositions, including quaternary and other higher order eutectic compositions, may be apparent to those skilled in the art after reviewing the present disclosure.

Sources, including commercial sources, of (on a theoretical oxide basis) Al₂O₃ include bauxite (including both natural occurring bauxite and synthetically produced bauxite), calcined bauxite, hydrated aluminas (e.g., boehmite and gibbsite), aluminum, Bayer process alumina, aluminum ore, gamma alumina, alpha alumina, aluminum salts, aluminum nitrates, and combinations thereof. The alumina source may contain, or only provide, alumina. Alternatively, the alumina source may contain, or provide Al₂O₃, as well as one or more metal oxides other than alumina (including materials of or containing complex Al₂O₃.metal oxides (e.g., Dy₃Al₅O₁₂, Y₃Al₅O₁₂, CeAl₁₁O₁₈, etc.)).

Sources, including commercial sources, of rare earth oxides include rare earth oxide powders, rare earth metals, rare earth-containing ores (e.g., bastnasite and monazite), rare earth salts, rare earth nitrates, and rare earth carbonates. The rare earth oxide(s) source may contain, or only provide, rare earth oxide(s). Alternatively, the rare earth oxide(s) source may contain, or provide rare earth oxide(s), as well as one or more metal oxides other than rare earth oxide(s) (including materials of or containing complex rare earth oxides or other metal oxides (e.g., Dy₃Al₅O₁₂, CeAl₁₁O₁₈, etc.)).

Sources, including commercial sources, of (on a theoretical oxide basis) alkaline earth oxide include alkaline salts, alkaline nitrates, and alkaline carbonates.

Sources, including commercial sources, of (on a theoretical oxide basis) yttrium oxide (Y₂O₃) include yttrium oxide powders, yttrium, yttrium-containing ores, and yttrium salts (e.g., yttrium carbonates, nitrates, chlorides, hydroxides, and combinations thereof). The yttrium oxide source may contain, or only provide, yttrium oxide. Alternatively, the yttrium oxide source may contain, or provide yttrium oxide, as well as one or more metal oxides other than yttrium oxide (including materials of or containing complex Y₂O₃.metal oxides (e.g., Y₃Al₅O₁₂)).

Sources, including commercial sources, of (on a theoretical oxide basis) zirconia (ZrO₂) include zirconium oxide powders, zircon sand, zirconium, zirconium-containing ores, and zirconium salts (e.g., zirconium carbonates, acetates, nitrates, chlorides, hydroxides, and combinations thereof). In addition, or alternatively, the zirconia source may contain, or provide zirconia, as well as other metal oxides such as hafnia. Sources, including commercial sources, of (on a theoretical oxide basis) hafnia (HfO₂) include hafnium oxide powders, hafnium, hafnium-containing ores, and hafnium salts. In addition, or alternatively, the hafnia source may contain, or provide hafnia, as well as other metal oxides such as zirconia.

Sources of other useful metal oxides, including commercial sources, include the oxides themselves, complex oxides, ores, carbonates, acetates, nitrates, chlorides, hydroxides, etc.

The particular selection of metal oxide sources and other additives for making ceramics typically takes into account, for example, the desired composition and microstructure of the resulting ceramics, the desired degree of crystallinity, if any, the desired physical properties (e.g., hardness or toughness) of the resulting ceramics, avoiding or minimizing the presence of undesirable impurities, the desired characteristics of the resulting ceramics, and/or the particular process (including equipment and any purification of the raw materials before and/or during fusion and/or solidification) being used to prepare the ceramics.

In some instances, it may be preferred to incorporate limited amounts of metal oxides selected from the group consisting of: boria, germanium oxide, phosphorus oxide, silica, tellurium oxide, and vanadium oxide, and combinations thereof. Sources, including commercial sources, include the oxides themselves, complex oxides, ores, carbonates, acetates, nitrates, chlorides, hydroxides, etc. These metal oxides may be added, for example, to modify a physical property of the resulting particles and/or improve processing. These metal oxides when used are typically added from greater than 0 to 20 percent by weight, preferably greater than 0 to 5 percent by weight and more preferably greater than 0 to 2 percent by weight of the glass-ceramic depending, for example, upon the desired property.

The addition of certain metal oxides may alter the properties and/or crystalline structure or microstructure of a glass-ceramic, as well as the processing of the raw materials and intermediates in making the glass-ceramics. For example, oxide additions such as magnesium oxide, calcium oxide, lithium oxide, and sodium oxide have been observed to alter both the T_{g} (for a glass) and Tₓ (wherein Tₓ is the crystallization temperature) of amorphous material. Although not wishing to be bound by theory, it is believed that such additions influence glass formation. Further, for example, such oxide additions may decrease the melting temperature of the overall system (i.e., drive the system toward lower melting eutectic), and ease of amorphous material-formation. Complex eutectics in multi-component systems (quaternary, etc.) may result in better amorphous material-forming ability. The viscosity of the liquid melt and viscosity of the glass in its “working” range may also be affected by the addition of certain metal oxides such as magnesium oxide, calcium oxide, lithium oxide, and sodium oxide. It is also within the scope of the present disclosure to incorporate at least one of halogens (e.g., fluorine and chlorine), or chalcogenides (e.g., sulfides, selenides, and tellurides) into the amorphous materials, and the glass-ceramics made therefrom.

Crystallization of the amorphous material and ceramic comprising the amorphous material may also be affected by the additions of certain materials. For example, certain metals, metal oxides (e.g., titanates and zirconates), and fluorides, for example, may act as nucleation agents resulting in beneficial heterogeneous nucleation of crystals. Also, addition of some oxides may change nature of metastable phases devitrifying from the amorphous material upon reheating. In another aspect, for ceramics comprising crystalline ZrO₂, it may be desirable to add metal oxides (e.g., yttrium oxide, titanium oxide, calcium oxide, and magnesium oxide) that are known to stabilize tetragonal/cubic form of zirconia.

The microstructure or phase composition (glassy/amorphous/crystalline) of a material can be determined in a number of ways. Various types of information can be obtained using optical microscopy, electron microscopy, differential thermal analysis (DTA), and x-ray diffraction (XRD), for example.

Using optical microscopy, amorphous material is typically predominantly transparent due to the lack of light scattering centers such as crystal boundaries, while crystalline material shows a crystalline structure and is transparent, translucent or opaque due to light scattering effects in the latter two cases.

Using DTA, the material is classified as amorphous if the corresponding DTA trace of the material contains an exothermic crystallization event (Tₓ). If the same trace also contains an endothermic event (T_{g}) at a temperature lower than Tₓ, it is considered to consist of a glass phase. If the DTA trace of the material contains no such events, it is considered to contain crystalline phases.

Differential thermal analysis (DTA) can be conducted using the following method. DTA runs can be made (using an instrument such as that obtained from Netzsch Instruments, Selb, Germany, under the trade designation “NETZSCH DSC-404-F1) using mesh size fractions to provide a collected fraction between about 180-micrometer opening size and 60-micrometer opening size screens. An amount of each screened sample (typically about 150 milligrams (mg)) is placed in a Pt sample holder. Each sample is heated in flowing argon at a rate of 20° C./minute from room temperature (about 25° C.) to about 1400° C.

Using powder x-ray diffraction, XRD, (using an x-ray diffractometer such as that obtained under the trade designation “PHILLIPS XRG 3100” from Phillips, Mahwah, N.J., with copper K_{α1} radiation of 1.54050 Angstrom) the phases present in a material can be determined by comparing the peaks present in the XRD trace of the crystallized material to XRD patterns of crystalline phases provided in JCPDS (Joint Committee on Powder Diffraction Standards) databases, published by International Center for Diffraction Data. Furthermore, an XRD can be used qualitatively to determine types of phases. The presence of a broad diffused intensity peak is taken as an indication of the amorphous nature of a material. The existence of both a broad peak and well-defined peaks is taken as an indication of existence of crystalline matter within an amorphous matrix.

The initially formed amorphous material or ceramic (including glass prior to crystallization) may be larger in size than that desired. The amorphous material or ceramic can be converted into smaller pieces using crushing and/or comminuting techniques known in the art, including roll crushing, canary milling, jaw crushing, hammer milling, ball milling, jet milling, impact crushing, and the like. The shape of the ceramic (including glass prior to crystallization) may depend, for example, on the composition and/or microstructure of the ceramic, the geometry in which it was cooled, and the manner in which the ceramic is crushed (i.e., the crushing technique used). In general, where a “blocky” shape is preferred, more energy may be employed to achieve this shape. Conversely, where a “sharp” shape is preferred, less energy may be employed to achieve this shape. The crushing technique may also be changed to achieve different desired shapes. The resulting particles may have an average aspect ratio ranging from 1:1 to 5:1, typically 1.25:1 to 3:1, and preferably 1.5:1 to 2.5:1.

It is also within the scope of the present disclosure, for example, to directly from ceramic (including glass prior to crystallization) in desired shapes. For example, ceramic (including glass prior to crystallization) may be formed (including molded) by pouring or forming the melt into a mold.

It is also within the scope of the present disclosure, for example, to fabricate the ceramic (including glass prior to crystallization) by coalescing. This coalescing step in essence forms a larger sized body from two or more smaller particles. For example, amorphous material comprising particles (obtained, for example, by crushing) (including beads and microspheres), fibers, etc. may be formed into an article. For example, ceramic (including glass prior to crystallization), may also be provided by heating, for example, particles comprising the amorphous material, and/or fibers, etc. above the T_{g} such that the particles, etc. coalesce to form a shape and cooling the coalesced shape. The temperature and pressure used for coalescing may depend, for example, upon composition of the amorphous material and the desired density of the resulting material. The temperature should be desirably below glass crystallization temperature, and for glasses, greater than the glass transition temperature. In some embodiments, the temperature used in coalescing may exceed the glass crystallization temperature. In certain embodiments, the heating is conducted at a temperature in a range of about 800° C. to about 1050° C. (in some embodiments, preferably 850° C. to 1000° C.). Typically, the amorphous material is under pressure (e.g., greater than zero to 1 GPa or more) during coalescence to aid the coalescence of the amorphous material.

In one embodiment, a charge of the particles, etc. is placed into a die and hot-pressing is performed at temperatures above glass transition where viscous flow of glass leads to coalescence into a relatively large part. Examples of typical coalescing techniques include hot pressing, hot isostatic pressure, hot extrusion, and the like. During this coalescence step, articles of complex shapes can be obtained by choosing suitable die constructions. Typically, it is generally preferred to cool the resulting coalesced body before further heat treatment.

In another embodiment, a coalesced perform comprising glass is placed into a die and is molded into useful shapes under the action of heat and pressure such that the perform flows. The pre-form may be glassy or partially crystalline. The pre-form may have a range of densities of from 50 to 100 of theoretical densities.

It is also within the scope of the present disclosure to conduct additional heat-treatment to further improve desirable properties of the material. For example, hot-isostatic pressing may be conducted (e.g., at temperatures from about 900° C. to about 1400° C.) to remove residual porosity, increasing the density of the material. Optionally, the resulting, coalesced article can be heat-treated to provide glass-ceramics.

Coalescence of the amorphous material (e.g., particles) may also be accomplished by a variety of methods, including pressureless or pressure sintering (e.g., sintering, plasma assisted sintering, hot pressing, HIPing, hot forging, hot extrusion, etc.). Coalescence of the amorphous material or shaping of an already coalesced body may be accomplished with the use of suitable dental presses that can deliver the required temperature and heat. One embodiment of this process comprises the steps of forming a refractory investment mold, inserting the material into the mold, heating, applying pressure to the material such that it fills the mold cavity to form the desired shape. An example of such a process is reported in U.S. Pat. No. 6,465,106 (Petticrew), incorporated by reference herein. A commercial example of such a press available, for example, under the trade designation “INTRA-TECH PROPRESS 100” from Whip-Mix Inc., Farmington, Ky.

In another embodiment, the materials of this disclosure can be formed into mill blanks and machined to a desired shaped product. The machining step can be accomplished in glassy, crystalline, or intermediate stages. Digitized CAD/CAM machining can be employed for this task. Examples of such systems include those under the trade designations “CEREC” from Sirona Dental Systems GmbH, Bensheim, Germany and “LAVA” from 3M Company, St. Paul, Minn. It has been surprisingly found that despite the high-strength nature of the material, it is quite machinable.

Heat-treatment can be carried out in any of a variety of ways, including those known in the art for heat-treating glass to provide glass-ceramics. For example, heat-treatment can be conducted in batches, for example, using resistive, inductively, or gas heated furnaces. Alternatively, for example, heat-treatment can be conducted continuously, for example, using a rotary kiln, fluidized bed furnace, or pendulum kiln. In the case of a rotary kiln or pendulum kiln, the material is fed directly into a kiln operating at the elevated temperature. The time at the elevated temperature may range from a few seconds (in some embodiments even less than 5 seconds) to a few minutes to several hours. The temperature may range anywhere from the T_{g} of the amorphous material to 1050° C., from 800° C. to 975° C., or from 820° C. to 950° C.

The glass is heat-treated to at least partially crystallize the amorphous material to provide glass-ceramic. The heat-treatment of certain glasses to form glass-ceramics is well known in the art. The heating conditions are generally carefully controlled to nucleate and grow crystals to provide desired microstructure and properties. One skilled in the art can determine the appropriate conditions from a Time-Temperature-Transformation (TTT) study of the glass using techniques known in the art. One skilled in the art, after reading the disclosure of the present disclosure should be able to provide TTT curves for glasses, determine the appropriate nucleation and/or crystal growth conditions to provide glass-ceramics.

In some embodiments of the present disclosure, the glasses or ceramics comprising glass may be annealed prior to heat-treatment. In such cases, annealing is typically done at a temperature less than the Tₓ of the glass for a time from a few seconds to a few hours or even days. Typically, the annealing is done for a period of less than 3 hours, or even less than an hour. Optionally, annealing may also be carried out in atmospheres other than air.

Heat-treatment may occur, for example, by feeding the material directly into a furnace at the elevated temperature. Alternatively, for example, the material may be fed into a furnace at a much lower temperature (e.g., room temperature) and then heated to desired temperature at a predetermined heating rate. It is within the scope of the present disclosure to conduct heat-treatment in an atmosphere other than air. In some cases it might be even desirable to heat-treat in a reducing atmosphere(s). Also, for example, it may be desirable to heat-treat under gas pressure as in, for example, hot-isostatic press, or in gas pressure furnace. Although not wanting to be bound by theory, it is believed that the T_{g} and Tₓ, as well as the Tₓ-T_{g} of glasses according to the present application may shift depending upon the atmospheres used during the heat treatment. It is also believed that the choice of atmospheres may affect oxidation states of some of the components of the glasses and glass-ceramics. Such variation in oxidation state can bring about varying coloration of glasses and glass-ceramics. In addition, nucleation and crystallization steps can be affected by atmospheres (e.g., the atmosphere may affect the atomic mobility of some species of the glasses).

Typically, glass-ceramics are stronger than the amorphous materials from which they are formed. Hence, the strength of the material may be adjusted, for example, by the degree to which the amorphous material is converted to crystalline ceramic phase(s). Surprisingly strength values of compositions heat-treated in a range from 800° C. to 1000° C. are relatively high. Alternatively, or in addition, the strength of the material may also be affected, for example, by the number of nucleation sites created, which may in turn be used to affect the number, and in turn the size of the crystals of the crystalline phase(s). For additional details regarding forming glass-ceramics, see, for example, Glass-Ceramics, P. W. McMillan, Academic Press, Inc., 2nd edition, 1979, the disclosure of which is incorporated herein by reference.

As compared to many other types of ceramic processing (e.g., sintering of a calcined material to a dense, sintered ceramic material), there is relatively little shrinkage (typically, less than 30 percent by volume; in some embodiments, less than 20 percent, 10 percent, 5 percent, or even less than 3 percent by volume) during crystallization of the glass to form the glass-ceramic. The actual amount of shrinkage depends, for example, on the composition of the glass, the heat-treatment time, the heat-treatment temperature, the heat-treatment pressure, the density of the glass being crystallized, the relative amount(s) of the crystalline phases formed, and the degree of crystallization. The amount of shrinkage can be measured by conventional techniques known in the art, including by dilatometry, Archimedes method, or measuring the dimensions material before and after heat-treatment. In cases, there may be some evolution of volatile species during heat-treatment.

For example, during heat-treatment of some exemplary amorphous materials containing ZrO₂ for making glass-ceramics according to present disclosure of phases such as La₂Zr₂O₇, (Zr,M)O₂ solid solution with face-centered cubic structure (where M=a stabilizing cation), cubic/tetragonal ZrO₂, in some cases monoclinic ZrO₂, have been observed at temperatures above about 900° C. Although not wanting to be bound by theory, it is believed that zirconia-related phases are the first phases to nucleate from the amorphous material. In amorphous materials that contain little or no ZrO₂ formation of Al₂O₃, ReAlO₃ (wherein Re is at least one rare earth cation), ReAl₁₁O₁₈, Re₃Al₅O₁₂, Y₃Al₅O₁₂, etc. phases takes place at temperatures above about 850° C. Surprisingly, it was found that initial precipitation of ReAlO₃ phase from glass can yield very high strength properties. The heat-treatment conditions that are optimum for obtaining such high strength are typically lower than what is needed to fully crystallize these glasses to a state of highest hardness. As a result, a unique property set that combines very high mechanical strength and intermediate hardness values (e.g., 8-12 GPa) can be obtained. This combination is useful, for example, for dental applications in which very high hardness of ceramic restorations are often associated with excessive wear of opposing tooth enamel, and thus undesirable.

Typically, crystallite size during this nucleation step is on the order of nanometers. For example, crystals as small as 10-15 nanometers have been observed. The size of the resulting crystals can typically be controlled at least in part by the nucleation and/or crystallization times and/or temperatures. Although it is generally preferred to have small crystals (e.g., on the order not greater than a micrometer, or even not greater than a 100 nanometers), glass-ceramics may be made with larger crystal sizes (e.g., at least 1-10 micrometers, at least 10-25 micrometers, at least 50-100 micrometers, or even greater than 100 micrometers). Although not wanting to be bound by theory, it is generally believed in the art that the finer the size of the crystals (for the same density), the higher the mechanical properties (e.g., strength) of the ceramic. In addition, very fine crystals can be beneficial in reducing friction coefficient in glass-ceramics, which correspondingly lowers wear of both glass-ceramic and a sliding partner. Useful crystal sizes are typically below 0.5 micrometer, or even below 0.2 micrometer. These properties are useful, for example, in applications such as, dental restoratives, orthodontic appliances, ceramic prostheses (e.g., hip and knee joints), ceramic bearings, milling media, and milling equipment components (e.g., liners, pins, etc.). It is also within the scope of this disclosure to perform crystallization in such a manner that crystals with needle, whisker or platelet-like morphologies form during heat-treatment. Such crystals could favorably affect fracture toughness, machinability, and other characteristics of the resultant glass-ceramic.

Examples of crystalline phases which may be present in embodiments of glass-ceramics include: Al₂O₃ (e.g., α-Al₂O₃ or transitional Al₂O₃), Y₂O₃, REO, HfO₂, ZrO₂ (e.g., cubic ZrO₂ and tetragonal ZrO₂), “complex metal oxides” (including “complex Al₂O₃.metal oxide (e.g., complex Al₂O₃.REO (e.g., ReAlO₃ (e.g., GdAlO₃ LaAlO₃), ReAl₁₁O₁₈ (e.g., LaAl11O₁₈), and Re₃Al₅O₁₂ (e.g., Dy₃Al₅O₁₂)), complex Al₂O₃.Y₂O₃ (e.g., Y₃Al₅O₁₂), and complex ZrO₂.REO (e.g., Re₂Zr₂O₇ (e.g., La₂Zr₂O₇))), and combinations thereof.

The average crystal size can be determined by the line intercept method according to the ASTM Standard E 112-96 “Standard Test Methods for Determining Average Grain Size”. The sample is mounted in mounting resin (such as that obtained under the trade designation “TRANSOPTIC POWDER” from Buehler Ltd., Lake Bluff, Ill.) typically in a cylinder of resin about 2.5 cm in diameter and about 1.9 cm high. The mounted section is prepared using conventional polishing techniques using a polisher (such as that obtained from Buehler Ltd., Lake Bluff, Ill., under the trade designation “ECOMET 3”). The sample is polished for about 3 minutes with a diamond wheel, followed by 5 minutes of polishing with each of 45, 30, 15, 9, 3, and 1-micrometer slurries. The mounted and polished sample is sputtered with a thin layer of gold-palladium and viewed using a scanning electron microscopy (such as the JEOL SEM Model JSM 840A). A typical back-scattered electron (BSE) micrograph of the microstructure found in the sample is used to determine the average crystal size as follows. The number of crystals that intersect per unit length (NL) of a random straight line drawn across the micrograph are counted. The average crystal size is determined from this number using the following equation:

$$AverageCrystalSize = \frac{1.5}{{N}_{L} M}$$

where N_{L} is the number of crystals intersected per unit length and M is the magnification of the micrograph.

Some embodiments of glass-ceramics described herein comprise crystals having at least one of an average crystal size not greater than 150 nanometers.

Some embodiments of the present disclosure include glass-ceramics comprising crystals, wherein at least 90 (in some embodiments preferably, 95, or even 100) percent by number of the crystals present in such portion have crystal sizes not greater than 200 nanometers.

Some embodiments of glass-ceramics described herein comprise Al₂O₃, a first complex Al₂O₃.REO, and optionally crystalline ZrO₂, and wherein at least one of the Al₂O₃, the optional crystalline ZrO₂, or the first complex Al₂O₃.REO has an average crystal size not greater than 150 nanometers. In some embodiments preferably, the glass-ceramics further comprise a second, different complex Al₂O₃.REO. In some embodiments preferably, the glass-ceramics further comprise a complex Al₂O₃.Y₂O₃.

Some embodiments of glass-ceramics described herein comprise a first complex Al₂O₃.REO, a second, different complex Al₂O₃.REO, and optionally crystalline ZrO₂, and wherein for at least one of the first complex Al₂O₃.REO, the second complex Al₂O₃.REO, or the optional crystalline ZrO₂, at least 90 (in some embodiments preferably, 95, or even 100) percent by number of the crystal sizes thereof are not greater than 200 nanometers. In some embodiments preferably, the glass-ceramics further comprise a complex Al₂O₃.Y₂O₃.

In some embodiments, glass-ceramics comprise at least 75, 80, 85, 90, 95, 97, 98, 99, or even 100 percent by volume crystallites, wherein the crystallites have an average size of less than 1 micrometer. In some embodiments, glass-ceramics comprise not greater than at least 75, 80, 85, 90, 95, 97, 98, 99, or even 100 percent by volume crystallites, wherein the crystallites have an average size not greater than 0.5 micrometer. In some embodiments, glass-ceramics comprise less than at 75, 80, 85, 90, 95, 97, 98, 99, or even 100 percent by volume crystallites, wherein the crystallites have an average size not greater than 0.3 micrometer. In some embodiments, glass-ceramics comprise less than at least 75, 80, 85, 90, 95, 97, 98, 99, or even 100 percent by volume crystallites, wherein the crystallites have an average size not greater than 0.15 micrometer.

Crystals formed by heat-treating amorphous to provide embodiments of glass-ceramics may be, for example, equiaxed, columnar, or flattened splat-like. The aspect ratio and overall size of whisker, needle, or platelet-like crystals maybe optionally controlled to improve properties.

Although a glass-ceramic may be in the form of a bulk material, it is also within the scope of the present disclosure to provide composites comprising a glass-ceramic. Such a composite may comprise, for example, a phase or fibers (continuous or discontinuous) or particles (including whiskers) (e.g., metal oxide particles, boride particles, carbide particles, nitride particles, diamond particles, metallic particles, glass particles, and combinations thereof) dispersed in a glass-ceramic described herein, or a layered-composite structure (e.g., a gradient of glass-ceramic to amorphous material used to make the glass-ceramic and/or layers of different compositions of glass-ceramics).

Typically, the (true) density, sometimes referred to as specific gravity, of ceramics is typically at least 70% of theoretical density. More desirably, the (true) density of ceramic is at least 75%, 80%, 85%, 90%, 92%, 95%, 96%, 97%, 98%, 99%, 99.5%, or even 100% of theoretical density.

The average hardness of glass-ceramics described herein can be determined as follows. Sections of the material are mounted in mounting resin (obtained under the trade designation “TRANSOPTIC POWDER” from Buehler Ltd., Lake Bluff, Ill.) typically in a cylinder of resin about 2.5 cm in diameter and about 1.9 cm high. The mounted section is prepared using conventional polishing techniques using a polisher (such as that obtained from Buehler Ltd., Lake Bluff, Ill., under the trade designation “ECOMET 3”). The sample is polished for about 3 minutes with a diamond wheel, followed by 5 minutes of polishing with each of 45, 30, 15, 9, 3, and 1-micrometer slurries. The microhardness measurements are made using a conventional microhardness tester (such as that obtained under the trade designation “MITUTOYO MVK-VL” from Mitutoyo Corporation, Tokyo, Japan) fitted with a Vickers indenter using a 100-gram indent load. The microhardness measurements are made according to the guidelines stated in ASTM Test Method E384 Test Methods for Microhardness of Materials (1991), the disclosure of which is incorporated herein by reference.

The average flexural strength of glass-ceramics described herein can be determined as described in the Average Flexural Strength Test described in the Examples below.

Mill blanks of dental or orthodontic material may be made in any desired shape or size, including cylinders, bars, cubes, polyhedra, ovoids, and plates as is known in the art. A variety of methods for forming and shaping the blanks into any desired configuration can be employed, such as press molding, and machining

Various means of milling the mill blanks may be employed to create custom-fit dental prosthetics having a desired shape and morphology. The term “milling” as used herein means abrading, polishing, controlled vaporization, electronic discharge milling (EDM), cutting by water jet or laser or any other method of cutting, removing, shaping, or carving material. While milling the blank by hand using a hand-held tool or instrument is possible, preferably the prosthetic is milled by machine, including computer controlled milling equipment. However, a preferred device to create a prosthetic and achieve the full benefits of the glass-ceramic is to use a CAD/CAM device capable of milling a blank, such as that available under the trade designation “SIRONA CEREC 2” from Sirona, Benesheim, Germany. By using a CAD/CAM milling device, the prosthetic can be fabricated efficiently and with precision. During milling, the contact area may be dry, or it may be flushed with a lubricant. Alternatively, it may be flushed with an air or gas stream. Suitable lubricants are well known in the art, and include water, oils, glycerin, ethylene glycols, and silicones. After machine milling, some degree of finishing, polishing, and adjustment may be necessary to obtain a custom fit in to the mouth and/or aesthetic appearance.

Glass-ceramics described herein are useful in making dental articles and orthodontic appliances that comprise glass-ceramics as described herein. The glass-ceramics described herein may, for example, be formed, molded, shaped, pressed, etc. into the form of dental articles and orthodontic appliances.

In one embodiment, a method of making a dental article or orthodontic appliance comprises optionally designing the dental article or the orthodontic appliance; carving a dental or orthodontic mill blank based on said optional design, wherein the dental mill blank comprises a ceramic comprising glass or glass-ceramics described herein. If the carved mill block is not in the desired glass-ceramic form, the carved mill block can be heat-treated as desired, including in some embodiments partially heat-treating the glass prior to carving.

In another embodiment, a method of making a dental article or an orthodontic appliance comprising designing the dental article or the orthodontic appliance, heating a glass above the T_{g} of the glass such that the glass coalesce (or forms, in the case of a perform) to form a dental article or an orthodontic appliance having a shape based on said optional design; and cooling the coalesced article, wherein the glass comprises at least one of the glasses described herein. The coalesced article may be further heat treated to form an article comprising glass-ceramic described herein. The glass may be in the form of at least one of particles, powder, fibers, flakes, whiskers, block, blank, or beads.

In another embodiment, a method of making a dental article or orthodontic appliance comprises optionally designing the dental article or the orthodontic appliance; combining a ceramic, glass, or glass-ceramic with a hardenable resin to form a mixture; forming the dental article or the orthodontic appliance into a shape based on said optional design; hardening said mixture to form the dental article or orthodontic appliance, wherein said ceramic comprises at least one of the glasses, or glass-ceramics described herein.

In another embodiment, the present disclosure provides a method of making a dental article or orthodontic appliance comprising the steps of plasma or thermally spraying particles comprising metal oxide sources onto a suitable substrate such that the particles coalesce to form a shaped article and optionally separating the shaped article or appliance from the substrate, wherein the shaped article comprises at least one of the glasses described herein. Useful substrates include refractory materials that comprise admixtures of silica, silicon carbide, magnesium oxide, mono ammonium phosphate, zircon or aluminum oxide. Metal substrates can also be used in some embodiments.

Dental materials and glass-ceramics disclosed in the present application can be used, for example, as artificial crowns, mill blanks, orthodontic appliances, dental articles, restoratives, and prostheses. For example, they may be fabricated into a prosthesis outside the mouth and subsequently adhered in place inside the mouth.

A dental article or orthodontic appliance can be attached to the tooth or bone structure with conventional cements or adhesives or other appropriate means such as glass ionomer, resin cement, zinc phosphate, zinc polycarboxylate, compomer, or resin-modified glass. In addition, material can optionally be added to the milled article or appliance for various purposes including repair, correction, or enhancing esthetics. The additional material may be of one or more different shades or colors. The added material may be composite, ceramic, or metal. A dental porcelain or light-cured composite is preferred.

Aesthetic quality of a dental article or orthodontic appliance, although a somewhat subjective characteristic (yet well-understood in the dental industry), can be preferably quantified in one aspect, by measuring MacBeth values as described in the Examples below, in which lower MacBeth values indicate a lower visual opacity. Visual opacity is indicative of dental article's or orthodontic appliance's level of translucency. Low visual opacity is desired so that the dental material will have a life-like luster.

High translucency of a dental article or orthodontic appliance contributes to the aesthetic character and quality of the material. Polishability of such articles and appliances also contributes to the aesthetic character and quality of the material. The ability of such articles and appliances to have a glossy finish and life-like luster upon polishing is highly desirable. An even greater benefit is the ability of such articles and appliances to retain their luster even after repetitive abrasive contact, such as tooth brushing. It has been surprisingly found that some embodiments of dental articles and orthodontic appliances disclosed in the present application have high polishability and are able to retain the polish and luster after repetitive tooth brushing.

Dental materials, dental articles, and orthodontic appliances described herein can be incorporated into kits, wherein at least one of the articles or appliances is a dental material, dental article or orthodontic appliance. The kits may also include one or more other components such as a dental mill blank, a bonding agent, a milling lubricant, a color-matching composition suitable for using in an oral environment, an impression material, an instrument, a dental composite, a paste, a dental porcelain, an abrasive, an orthodontic adhesive, an adhesive primer, an appliance positioning tool, instructions for the use of any of these components alone or in combination with any other component or components, and combinations thereof.

Other uses of glass-ceramics described herein are as materials for dental restorations applied by flame spraying as reported in U.S. Pat. No. 6,938,990 B1 (Silverbrook), incorporated by reference herein; in the forming methods reported in U.S. Pat. No. 6,342,458 B1 (Schweiger et al.), incorporated by reference herein; as dental mill blanks as described in U.S. Pat. No. 6,394,880 (Basler et al.), incorporated by reference herein; as a porous material for glass infiltration as described in U.S. Pat. No. 5,910,273 (Thiel et al.) and U.S. Pat. No. 5,250,352 (Tyszblat), incorporated by reference herein.

### Exemplary Embodiments

1. A glass-ceramic comprising at least 20 (in some embodiments, at least 25, 30, 35, 40, 45, 50, or even at least 55; in some embodiments, in a range from 20 to 60, 25 to 60, 30 to 60, 35 to 60, 40 to 60; or even 25 to 45) percent by weight alumina and at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight collectively of rare earth oxide, yttrium oxide, and alkaline earth oxide (including in some embodiments (a) zero alkaline earth oxide and at least 15 percent by weight collectively rare earth oxide and yttrium oxide (understood to mean in some embodiments there may be at least 15 percent by weight rare earth oxide and zero yttrium oxide and vice versa); or (b) at least 15 percent alkaline earth oxide and zero collectively rare earth oxide and yttrium oxide), based on the total weight of the glass-ceramic, wherein the rare earth is selected from the group consisting of La, Ce, Pr, Nd, Sm, Eu, Gd, and combinations thereof, wherein the alkaline earth oxide is selected from the group consisting of BaO, CaO, SrO, MgO, and combinations thereof, wherein the molar ratio of the alumina to the collective rare earth oxide, yttrium oxide, and alkaline earth oxide is up to 3.2 (in some embodiments, up to 3.1, 3, 2.9, 2.8, 2.7, 2.6, 2.5, 2.4, or even up to 2.3; in some embodiments, in a range from 1 to 3.2, 1.2 to 3.2, 1.5 to 3.2, 2 to 3, or even 2.3 to 2.9), and wherein the glass-ceramic has an average hardness in a range from 8 GPa to 12 GPa (in some embodiments, 8 GPa to 11 GPa) and an average flexural strength of at least 500 MPa (in some embodiments, at least in 550 MPa, 600 MPa, 650 MPa, 700 MPa, 750 MPa, 1 GPa, 1.25 GPa, 1.5 GPa, 1.75 GPa, 2 GPa, 2.25 GPa, or even at least 2.5 GPa).

2. The glass-ceramic of Embodiment 1 comprising at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight of the collectively rare earth oxide and yttrium oxide (understood to mean in some embodiments there may be at least 15 percent by weight rare earth oxide and zero yttrium oxide and vice versa).

3. The glass-ceramic of Embodiment 1 comprising at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight of the alkaline earth oxide.

4. The glass-ceramic of any preceding Embodiment, wherein at least a portion of the alumina and rare earth oxide are present as at least 20 (in some embodiments, at least 25, 30, 35, 40, 45, 50, or even at least 55; in some embodiments, in a range from 20 to 60, 30 to 60, or even 40 to 60) percent by volume of ReAlO₃, based on the total volume of the glass-ceramic, and wherein Re is selected from the group consisting of La, Ce, Pr, Nd, Sm, Eu, Gd, and combinations thereof.

5. The glass-ceramic of any preceding Embodiment that is optically translucent.

6. The glass-ceramic of any preceding Embodiment further comprising at least 5 (in some embodiments, at least 10) percent by weight collectively zirconia and hafnia (understood to mean in some embodiments there may be at least 5 percent by weight zirconia and vice versa), based on the total weight of the glass-ceramic, wherein the molar ratio of alumina to collectively rare earth oxide yttrium oxide, and alkaline earth oxide (understood to the extent, if at all, such oxides are present is up to 3.

7. The glass-ceramic of any preceding Embodiment, wherein the glass-ceramic collectively comprises at least 80 (in some embodiments, at least 85, or even at least 90) percent of alumina, collectively rare earth oxide and yttrium oxide, and alkaline earth oxide selected from the group consisting of BaO, CaO, SrO, MgO, and combinations thereof, and at least one of zirconia or hafnia, based on the total weight of the glass-ceramic (understood to the extent, if at all, such oxides are present).

8. The glass-ceramic of any preceding Embodiment, wherein the glass-ceramic has an average grain size less than 250 nm (in some embodiments, less than 200 nm, 150 nm, or even less than 100 nm).

9. The glass-ceramic of any preceding Embodiment, wherein the glass-ceramic collectively comprises at least 60 (in some embodiments, at least 65, or even at least 70) percent of alumina, collectively rare earth oxide and yttrium oxide, and alkaline earth oxide selected from the group consisting of BaO, CaO, SrO, MgO, and combinations thereof, based on the total weight of the glass-ceramic (understood to the extent, if at all, such oxides are present).

10. The glass-ceramic of any preceding Embodiment, further comprising at least one of niobium oxide, tantalum oxide, titanium oxide, lithium oxide, potassium oxide, or sodium oxide (in some embodiments, up to 5, 10, 15, or even up to 20 percent by weight collectively of niobium oxide, tantalum oxide, titanium oxide, lithium oxide, potassium oxide, and sodium oxide, based on the total weight of the glass-ceramic (understood to the extent, if at all, such oxides are present)).

11. The glass-ceramic of any preceding Embodiment further comprising at least one of ytterbium oxide or erbium oxide (in some embodiments, up to 5, 10, 15, or even up to 20 percent by weight collectively ytterbium oxide and erbium oxide, based on the total weight of the glass-ceramic).

12. The glass-ceramic of any preceding Embodiment, wherein the glass-ceramic contains not more than 20 (in some embodiments, not more than 15, 10, or even not more than 5) percent by weight collectively boria, germanium oxide, phosphorus oxide, silica, tellurium oxide, and vanadium oxide, based on the total weight of the glass-ceramic.

13. The glass-ceramic of any of Embodiments 1 to 11, wherein the glass-ceramic contains not more than 20 (in some embodiments, not more than 15, 10, or even not more than 5) percent by weight collectively silica, based on the total weight of the glass-ceramic.

14. The glass-ceramic of any preceding Embodiment, wherein the glass-ceramic is a dental article.

15. The dental article of Embodiment 14, wherein the dental article is selected from the group consisting of restoratives, replacements, inlays, onlays, veneers, full and partial crowns, bridges, implants, implant abutments, copings, anterior fillings, posterior fillings, cavity liner, and bridge frameworks.

16. The glass-ceramic of any of Embodiments 1 to 13, wherein the glass-ceramic is an orthodontic appliance.

17. The orthodontic appliance of Embodiment 16, wherein the orthodontic appliance is selected from the group consisting of brackets, buccal tubes, cleats, and button.

18. Abrasive particles comprising the glass-ceramic of any of Embodiments 1 to 13.

19. An abrasive article comprising binder and abrasive particles of Embodiment 18.

20. A cutting tools comprising the glass-ceramic of any of Embodiments 1 to 13.

21. An infrared window comprising the glass-ceramic of any of Embodiments 1 to 13.

22. Ceramic bearings comprising the glass-ceramic of any of Embodiments 1 to 13.

23. A method of making the glass-ceramic of any of Embodiments 1 to 13, the method comprising heat-treating a glass having a Tₓ and the glass comprising at least 20 (in some embodiments, at least 25, 30, 35, 40, 45, 50, or even at least 55; in some embodiments, in a range from 20 to 60, 25 to 60, 30 to 60, 35 to 60, 40 to 60; or even 25 to 45) percent by weight alumina and at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight collectively of rare earth oxide, yttrium oxide, and alkaline earth oxide, based on the total weight of the glass-ceramic, wherein the rare earth is selected from the group consisting of La, Ce, Pr, Nd, Sm, Eu, Gd, and combinations thereof, wherein the alkaline earth oxide is selected from the group consisting of BaO, CaO, SrO, MgO, and combinations thereof, wherein the molar ratio of the alumina to the collective rare earth oxide, yttrium oxide. and alkaline earth oxide is up to 3.2 (in some embodiments, up to 3.1, 3, 2.9, 2.8, 2.7, 2.6, 2.5, 2.4, or even up to 2.3; in some embodiments, in a range from 1 to 3.2, 1.2 to 3.2, 1.5 to 3.2, 2 to 3, or even 2.3 to 2.9), to provide the glass-ceramic.

24. A method of making one of a dental article or an orthodontic appliance comprising: providing a glass having a T_{g} and Tₓ, and the glass comprising at least 20 (in some embodiments, at least 25, 30, 35, 40, 45, 50, or even at least 55; in some embodiments, in a range from 20 to 60, 25 to 60, 30 to 60, 35 to 60, 40 to 60; or even 25 to 45) percent by weight alumina and at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight collectively of rare earth oxide, yttrium oxide, and alkaline earth oxide, based on the total weight of the glass-ceramic, wherein the rare earth is selected from the group consisting of La, Ce, Pr, Nd, Sm, Eu, Gd, and combinations thereof, wherein the alkaline earth oxide is selected from the group consisting of BaO, CaO, SrO, MgO, and combinations thereof, wherein the molar ratio of the alumina to the collective rare earth oxide, yttrium oxide, and alkaline earth oxide is up to 3.2 (in some embodiments, up to 3.1, 3, 2.9, 2.8, 2.7, 2.6, 2.5, 2.4, or even up to 2.3; in some embodiments, in a range from 1 to 3.2, 1.2 to 3.2, 1.5 to 3.2, 2 to 3, or even 2.3 to 2.9)

heating the glass above the T_{g} such that the glass deforms to form one of a dental article or an orthodontic appliance having a shape;

optionally cooling the shaped glass article; and

heat-treating the glass article in a range from 800° C. to 1050° C. to convert at least a portion of the glass to glass-ceramic of any of Embodiments 1 to 13.

25. The method of Embodiment 24, wherein the glass is in the form of at least one of fibers, flakes, whiskers, beads, or a block.

26. A method of making one of a dental article or an orthodontic appliance comprising:

providing one of a dental mill blank or an orthodontic mill blank comprising a glass having a T_{g} and Tₓ, and the glass comprising (in some embodiments, at least 25, 30, 35, 40, 45, 50, or even at least 55; in some embodiments, in a range from 20 to 60, 25 to 60, 30 to 60, 35 to 60, 40 to 60; or even 25 to 45) percent by weight alumina and at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight collectively of rare earth oxide, yttrium oxide, and alkaline earth oxide, based on the total weight of the glass, wherein the rare earth is selected from the group consisting of La, Ce, Pr, Nd, Sm, Eu, Gd, and combinations thereof, wherein the alkaline earth oxide is selected from the group consisting of BaO, CaO, SrO, MgO, and combinations thereof, wherein the molar ratio of the alumina to the collective rare earth oxide, yttrium oxide, and alkaline earth oxide is up to 3.2 (in some embodiments, up to 3.1, 3, 2.9, 2.8, 2.7, 2.6, 2.5, 2.4, or even up to 2.3; in some embodiments, in a range from 1.8 to 3.2, 1.9 to 3.2, 2 to 3.2, 2 to 3, or even 2.3 to 2.9);

carving the dental mill blank or orthodontic mill blank to provide the dental article or orthodontic appliance; and

heat-treating the glass in a range from 800° C. to 950° C. to convert at least a portion of the glass to glass-ceramic of any of Embodiments 1 to 13. Optionally, the glass is partially heat-treated prior to carving.

27. A method of performing a dental restoration comprising:
preparing a dental site to be restored; and
applying a restorative material comprising glass-ceramic of any of Embodiments 1 to 13.

28. The method of Embodiment 29, wherein the restorative material is selected from the group consisting of veneers, crowns, inlays, onlays, bridge structures, and combinations thereof.

29. A glass-ceramic comprising at least 20 (in some embodiments, at least 25, 30, 35, 40, 45, 50, or even at least 55; in some embodiments, in a range from 20 to 60, 25 to 60, 30 to 60, 35 to 60, 40 to 60; or even 25 to 45) percent by weight alumina and at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight rare earth oxide, based on the total weight of the glass-ceramic, wherein the rare earth is selected from the group consisting of La, Ce, Pr, Nd, Sm, Eu, Gd, and combinations thereof, wherein the molar ratio of alumina to rare earth oxide is up to 3.2 (in some embodiments, up to 3.1, 3, 2.9, 2.8, 2.7, 2.6, 2.5, 2.4, or even up to 2.3; in some embodiments, in a range from 2 to 3.2, 2 to 3, or even 2.3 to 2.9), wherein at least a portion of the alumina and rare earth oxide are present as at least 30 (in some embodiments, at least 35, 40, 45, 50, or even at least 55; in some embodiments, in a range from 30 to 60, 35 to 60, or even 40 to 60) percent by volume of ReAlO₃, wherein Re is selected from the group consisting of La, Ce, Pr, Nd, Sm, Eu, Gd, and combinations thereof, and wherein the glass-ceramic has an average flexural strength of at least 1.5 GPa (at least in some embodiments at least 1.75 GPa, 2 GPa, 2.25 GPa, or even at least 2.5 GPa).

30. The glass-ceramic of Embodiment 29, wherein the glass-ceramic has an average hardness in a range from 8 GPa to 12 GPa (in some embodiments, 8 GPa to 11 GPa).

31. The glass-ceramic of either Embodiment 29 or 30 that is optically translucent.

32. The glass-ceramic of any Embodiments 29 to 31 further comprising at least 5 (in some embodiments, at least 10) percent by weight collectively of at least one of zirconia or hafnia, based on the total weight of the glass-ceramic, wherein the molar ratio of alumina to rare earth oxide is up to 3.

33. The glass-ceramic of any Embodiments 29 to 32, wherein the glass-ceramic collectively comprises at least 80 (in some embodiments, at least 85, or even at least 90) percent of the alumina, the rare earth oxide, and the at least one of zirconia or hafnia, based on the total weight of the glass-ceramic.

34. The glass-ceramic of any Embodiments 29 to 33, wherein the glass-ceramic has an average grain size less than 250 nm (in some embodiments, less than 200 nm, 150 nm, or even less than 100 nm).

35. The glass-ceramic of any Embodiments 30 to 34, wherein the glass-ceramic collectively comprises at least 60 (in some embodiments, at least 65, or even at least 70) percent of the alumina and the rare earth oxide, based on the total weight of the glass-ceramic.

36. The glass-ceramic of any Embodiments 29 to 35, further comprising at least one of niobium oxide, tantalum oxide, titanium oxide, lithium oxide, potassium oxide, or sodium oxide (in some embodiments, up to 5, 10, 15, or even up to 20 percent by weight collectively of niobium oxide, tantalum oxide, titanium oxide, lithium oxide, potassium oxide, and sodium oxide, based on the total weight of the glass-ceramic (understood to the extent, if at all, such oxides are present)).

37. The glass-ceramic of any Embodiments 29 to 36 further comprising at one of yttrium oxide, ytterbium oxide, erbium oxide (in some embodiments, up to 5, 10, 15, or even up to 20 percent by weight collectively of yttrium oxide, ytterbium oxide, and erbium oxide, based on the total weight of the glass-ceramic).

38. The glass-ceramic of any Embodiments 29 to 37 further comprising alkaline earth oxide selected from the group consisting of BaO, CaO, SrO, MgO, and combinations thereof.

39. The glass-ceramic of any Embodiments 29 to 38, wherein the glass-ceramic contains not more than 20 (in some embodiments, not more than 15, 10, or even not more than 5) percent by weight collectively boria, germanium oxide, phosphorus oxide, silica, tellurium oxide, and vanadium oxide, based on the total weight of the glass-ceramic.

40. The glass-ceramic of any Embodiments 29 to 38, wherein the glass-ceramic contains not more than 20 (in some embodiments, not more than 15, 10, or even not more than 5) percent by weight collectively silica, based on the total weight of the glass-ceramic.

41. The glass-ceramic of any Embodiments 29 to 40, wherein the glass-ceramic is a dental article.

42. The dental article of Embodiment 41, wherein the dental article is selected from the group consisting of restoratives, replacements, inlays, onlays, veneers, full and partial crowns, bridges, implants, implant abutments, copings, anterior fillings, posterior fillings, cavity liner, and bridge frameworks.

43. The glass-ceramic of any Embodiments 29 to 40, wherein the glass-ceramic is an orthodontic appliance.

44. The orthodontic appliance of Embodiment 43, wherein the orthodontic appliance is selected from the group consisting of brackets, buccal tubes, cleats, and button.

45. Abrasive particles comprising the glass-ceramic of any Embodiments 29 to 40.

46. An abrasive article comprising binder and abrasive particles of Embodiment 45.

47. A cutting tools comprising the glass-ceramic of any Embodiments 29 to 40.

48. An infrared window comprising the glass-ceramic of any Embodiments 29 to 40.

49. Ceramic bearings comprising the glass-ceramic of any Embodiments 29 to 40.

50. A method of making the glass-ceramic of any Embodiments 29 to 40, the method comprising heat-treating a glass having a Tₓ and the glass comprising at least 20 (in some embodiments, at least 25, 30, 35, 40, 45, 50, or even at least 55; in some embodiments, in a range from 20 to 60, 25 to 60, 30 to 60, 35 to 60, 40 to 60; or even 25 to 45) percent by weight alumina and at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight rare earth oxide, based on the total weight of the glass, wherein the rare earth is selected from the group consisting of La, Ce, Pr, Nd, Sm, Eu, Gd, and combinations thereof, wherein the molar ratio of alumina to rare earth oxide is up to 3.2 (in some embodiments, up to 3.1, 3, 2.9, 2.8, 2.7, 2.6, 2.5, 2.4, or even up to 2.3; in some embodiments, in a range from 1.8 to 3.2, 1.9 to 3.2, 2 to 3.2, 2 to 3, or even 2.3 to 2.9), wherein at least a portion of the alumina and rare earth oxide are present as at least 30 (in some embodiments, at least 35, 40, 45, 50, or even at least 55; in some embodiments, in a range from 30 to 60, 35 to 60, or even 40 to 60) percent by volume of ReAlO₃, and wherein Re is selected from the group consisting of La, Ce, Pr, Nd, Sm, Eu, Gd, and combinations thereof, to provide the glass-ceramic.

51. A method of making one of a dental article or an orthodontic appliance comprising:

providing a glass having a T_{g} and Tₓ, and the glass comprising at least 20 (in some embodiments, at least 25, 30, 35, 40, 45, 50, or even at least 55; in some embodiments, in a range from 20 to 60, 25 to 60, 30 to 60, 35 to 60, 40 to 60; or even 25 to 45) percent by weight alumina and at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight rare earth oxide, based on the total weight of the glass, wherein the rare earth is selected from the group consisting of La, Ce, Pr, Nd, Sm, Eu, Gd, and combinations thereof, wherein the molar ratio of alumina to rare earth oxide is up to 3.2 (in some embodiments, up to 3.1, 3, 2.9, 2.8, 2.7, 2.6, 2.5, 2.4, or even up to 2.3; in some embodiments, in a range from 1.8 to 3.2, 1.9 to 3.2, 2 to 3.2, 2 to 3, or even 2.3 to 2.9) wherein at least a portion of the alumina and rare earth oxide are present as at least 30 (in some embodiments, at least 35, 40, 45, 50, or even at least 55; in some embodiments, in a range from 30 to 60, 35 to 60, or even 40 to 60) percent by volume of ReAlO₃, and wherein Re is selected from the group consisting of La, Ce, Pr, Nd, Sm, Eu, Gd, and combinations thereof;

heating the glass above the T_{g} such that the glass deforms to form one of a dental article or an orthodontic appliance having a shape;

optionally cooling the shaped glass article; and

heat-treating the glass article in a range from 800° C. to 1050° C. to convert at least a portion of the glass to glass-ceramic of any Embodiments 29 to 40.

52. The method of Embodiment 51, wherein the glass is in the form of at least one of fibers, flakes, whiskers, beads, or a block.

53. A method of making one of a dental article or an orthodontic appliance comprising:

providing one of a dental mill blank or an orthodontic mill blank comprising a glass having a T_{g} and Tₓ, and the glass comprising at least 20 (in some embodiments, at least 25, 30, 35, 40, 45, 50, or even at least 55; in some embodiments, in a range from 20 to 60, 25 to 60, 30 to 60, 35 to 60, 40 to 60; or even 25 to 45) percent by weight alumina and at least 15 (in some embodiments, at least 20, 25, 30, 35, 40, 45, 50, or even at least 55; in some embodiments, in a range from 15 to 60, 20 to 60, 25 to 60, 30 to 60, 35 to 60, 40 to 60; or even 40 to 50) percent by weight rare earth oxide, based on the total weight of the glass, wherein the rare earth is selected from the group consisting of La, Ce, Pr, Nd, Sm, Eu, Gd, and combinations thereof, wherein the molar ratio of alumina to rare earth oxide is up to 3.2 (in some embodiments, up to 3.1, 3, 2.9, 2.8, 2.7, 2.6, 2.5, 2.4, or even up to 2.3; in some embodiments, in a range from 1.8 to 3.2, 1.9 to 3.2, 2 to 3.2, 2 to 3, or even 2.3 to 2.9), wherein at least a portion of the alumina and rare earth oxide are present as at least 30 (in some embodiments, at least 35, 40, 45, 50, or even at least 55; in some embodiments, in a range from 30 to 60, 35 to 60, or even 40 to 60) percent by volume of ReAlO₃, and wherein Re is selected from the group consisting of La, Ce, Pr, Nd, Sm, Eu, Gd, and combinations thereof;

carving the dental mill blank or orthodontic mill blank to provide the dental article or orthodontic appliance; and

heat-treating the glass in a range from 800° C. to 950° C. to convert at least a portion of the glass to glass-ceramic of any Embodiments 30 to 41. Optionally, the glass is partially heat-treated prior to carving.

54. A method of performing a dental restoration comprising:
preparing a dental site to be restored; and
applying a restorative material comprising glass-ceramic of any Embodiments 29 to 40.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### Example 1

Example 1 was prepared by charging a plastic bottle with 4.77 grams of lanthanum oxide particles (obtained from Molycorp, Inc., Greenwood Village, Colo.), 3.66 grams of alumina particles (obtained from Alcoa Industrial Chemicals, Bauxite, Ark., under the trade designation “A16SG”), 1.57 grams of zirconium oxide particles (obtained from Z-Tech Inc., Bow, N.H.) and 100 grams of alumina milling media (cylindrical shape, both height and diameter of 0.635 cm; 99.9% alumina; obtained from CoorsTek, Golden, Colo.).

The contents of the plastic bottle were milled for 1 hour at 60 revolutions per minute (rpm). After the milling, the milling media were removed and the powder mix was dried in an oven at 110° C. The dried mixture was melted and cooled using a laser melting together with aerodynamic levitation as described in U.S. Pat. No. 6,482,758 (Weber et al.), the disclosure of which is incorporated herein by reference. Formation of clear glass gobs about 3-5 mm in diameter was observed.

About 30 glass gobs (3-4 mm diameter each) were placed between two graphite plates, heated to 915° C. and flattened into glass disks about 0.5 mm-0.8 mm in thickness and 5-7 mm in diameter using 5 MPa of uniaxially applied pressure. The glass disks were subsequently heat-treated in a vacuum furnace (obtained under the trade designation “PRO PRESS 100” from Whip Mix, Louisville, Ky.) at temperatures increasing from 890° C. to 950° C. with a 10° C. interval with a 30-minute hold (7 disks per each heat-treatment condition) at each temperature.

The Average biaxial Strength was then obtained in accordance with ISO 6872 standard (2008) except that a new fixture in which all dimensions were half of that of the standard was utilized (“Average Biaxial Strength Test”). Strength was measured on the as-prepared surfaces without any additional polishing. Material heat treated at 910° C. for 30 minutes had an average biaxial strength of 250 MPa, whereas as material heat-treated at 920° C. for 30 minutes had an average biaxial strength of 2050 MPa. By X-Ray diffraction analysis it was determined that material contained only La₂Zr₂O₇ phase after heat-treatment at 910° C. and both La₂Zr₂O₇ phase and LaAlO₃ phase after heat-treatment at 920° C. The volume fraction of the latter phase was about 35% (as determined by X-Ray analysis).

Optical translucency of the glass discs were measured with the use of an optical densitometer (obtained under the trade designation “MACBETH TD504” from Macbeth Inc. Optical translucency of the sample was 55% after the first heat treatment and 18% after the second heat treatment.

### Examples 2-33

Examples 2-5 were prepared as described in Example 1, except that starting compositions and heat-treatment temperatures were varied as shown in Table 1, below (all in mol. %).

TABLE 1

| Example | Al₂O₃ | La₂O₃ | ZrO₂ | SiO₂ | CeO₂ | Gd₂O₃ | Nb₂O₅ | TiO₂ | HfO₂ | BaO | CaO |
|---|---|---|---|---|---|---|---|---|---|---|---|
| 2 | 62.33 | 22.67 | 15.00 | | | | | | | | |
| 3 | 62.77 | 22.28 | 15.00 | | | | | | | | |
| 4 | 53.57 | 21.43 | 25.00 | | | | | | | | |
| 5 | 53.87 | 21.13 | 25.00 | | | | | | | | |
| 6 | 62.49 | 25.51 | 12.00 | | | | | | | | |
| 7 | 60.36 | 24.64 | 15.00 | | | | | | | | |
| 8 | 62.49 | 25.51 | | | | | | | 12.00 | | |
| 9 | 65.34 | 26.66 | 8.00 | | | | | | | | |
| 10 | 53.55 | 21.45 | 25.00 | | 1.00 | | | | | | |
| 11 | 62.49 | 25.51 | 7.00 | | | | | 5.00 | | | |
| 12 | 62.49 | | 12.00 | | | 25.51 | | | | | |
| 13 | 56.81 | 23.18 | 20.00 | | | | | | | | |
| 14 | 62.49 | 25.51 | 7.00 | | | | 5.00 | | | | |
| 15 | 58.90 | 21.16 | 11.88 | 8.06 | | | | | | | |
| 16 | 55.61 | 21.39 | 18.00 | 5.00 | | | | | | | |
| 17 | 52.30 | 21.64 | 24.12 | 1.94 | | | | | | | |
| 18 | 56.63 | 23.44 | 11.88 | 8.06 | | | | | | | |
| 19 | 55.61 | 21.39 | 18.00 | 5.00 | | | | | | | |
| 20 | 63.41 | 22.78 | 11.88 | 1.94 | | | | | | | |
| 21 | 60.96 | 25.23 | 11.88 | 1.94 | | | | | | | |
| 22 | 59.22 | 22.78 | 18.00 | 0.00 | | | | | | | |
| 23 | 53.67 | 23.33 | 18.00 | 5.00 | | | | | | | |
| 24 | 62.83 | 24.17 | 8.00 | 5.00 | | | | | | | |
| 25 | 56.58 | 20.42 | 20.00 | 3.00 | | | | | | | |
| 26 | 53.83 | 14.57 | 19.03 | 2.85 | | | | | | 9.72 | |
| 27 | 51.33 | 9.27 | 18.53 | 2.72 | | | | | | 18.53 | |
| 28 | 49.06 | 4.43 | 17.34 | 2.6 | | | | | | 26.57 | |
| 29 | 46.98 | | 16.61 | 2.49 | | | | | | 33.92 | |
| 30 | 53.83 | 14.57 | 19.03 | 2.85 | | | | | | | 9.72 |
| 31 | 51.33 | 9.27 | 18.53 | 2.72 | | | | | | | 18.53 |
| 32 | 49.06 | 4.43 | 17.34 | 2.6 | | | | | | | 26.57 |
| 33 | 46.98 | | 16.61 | 2.49 | | | | | | | 33.92 |

Biaxial strength and optical characteristics of Example 2-33 materials after heat treatment were determined as described above in Example 1. Table 2 (below) summarizes the heat treatment temperatures used for samples of Examples 2-33 as well as the corresponding biaxial strength, hardness, and % light transmission data for those samples after the indicated heat treatment.

TABLE 2

| | Heat-Treatment | Biaxial | | Light |
|---|---|---|---|---|
| | temperatures, | Strength, | | Trans- |
| | ° C., (30 min | MPa (aver- | | mission, % |
| | hold at each | age of 7 | Hardness, | (0.8 mm |
| Example | temperature) | samples) | GPa | thick disk) |
| 2 | 905/920 | 2100 | 9.4 | 54 |
| 3 | 905/920 | 1090 | 9.3 | 64 |
| 4 | 905/920 | 1150 | 9.5 | 67 |
| 5 | 905/920 | 1050 | 9.2 | 71 |
| 6 | 905/920 | 2150 | 9.9 | 30 |
| 7 | 905/920 | 1970 | 9.7 | 37 |
| 8 | 905/920 | 2180 | 9.8 | 44 |
| 9 | 905/920 | 2560 | 10.1 | 27 |
| 10 | 905/920 | 1100 | 9.6 | 66 |
| 11 | 905/920 | 1290 | 9.7 | 38 |
| 12 | 905/920/940 | 680 | 11.8 | 65 |
| 13 | 905/920 | 1980 | 9.4 | 44 |
| 14 | 905/920 | 1470 | 9.3 | 48 |
| 15 | 890/910 | 520 | 9.4 | 32 |
| 16 | 890/910 | 514 | 9.5 | 64 |
| 17 | 890/910 | 944 | 9.7 | 71 |
| 18 | 890/910 | 527 | 9.8 | 37 |
| 19 | 890/910 | 505 | 9.2 | 63 |
| 20 | 890/910 | 567 | 9.1 | 68 |
| 21 | 890/910 | 1591 | 9.0 | 21 |
| 22 | 890/910 | 1004 | | 63 |
| 23 | 890/910 | 773.0 | | 16 |
| 24 | 890/910 | 1078 | | 32 |
| 25 | 890/910 | 532 | | 61 |
| 26 | 890/910 | | | 71 |
| 27 | 890/910 | 1051 | | 69 |
| 28 | 890/910 | | | 72 |
| 29 | 890/910 | | | 73 |
| 30 | 890/910 | | | 64 |
| 31 | 890/910 | 1158 | | 69 |
| 32 | 890/910 | | | 72 |
| 33 | 890/910 | | | 73 |

### Example 34

A plastic bottle was charged with 43 grams of isopropyl alcohol, 1 gram of a dispersant (obtained under trade designation “SOLSPERSE 20000” from Lubrizol Corporation, Wickliffe, Ohio), and 3 grams of polyvinylpyrrolidone. Then the following oxide powders were added: 36.75 grams of Al₂O₃—, 31.5 grams La₂O₃, 1.6 gram of Gd₂O₃, and 30.16 grams of HfO₂—. About 1000 grams of alumina milling media was added to the bottle, and the contents milled for 24 hrs at 120 rpm. After milling, a few drops of deionized water were added which led to thickening of the slurry into a gel-like consistency. This gelatine-like substance was then transferred into glass trays and dried in an air oven at 121° C.

After grinding with a mortar and pestle, a portion of the dried powder was fed into a hydrogen/oxygen torch flame to generate melted glass beads. The torch used to melt the particles, thereby generating melted glass beads, was a bench burner (obtained under the trade designation “PM2D: Model B Bethlehem Apparatus Co., Hellertown, Pa.) delivering hydrogen and oxygen at the following rates. For the inner ring, the hydrogen flow rate was 8 standard liters per minute (SLPM) and the oxygen flow rate was 3 SLPM. For the outer ring, the hydrogen flow rate was 23 (SLPM) and the oxygen flow rate was 9.8 SLPM.

The resulting molten and quenched particles were collected in a pan and dried at 110° C. The particles were spherical in shape and ranged in size from a few tens of micrometers to up to 250 micrometers. From the fraction of beads measuring from 63 micrometers to 125 micrometers, greater than 95% were clear when viewed by an optical microscope.

Three grams of beads sized from 90 micrometers to 125 micrometers was placed in a graphite die (10 mm in diameter) and hot-pressed at 915° C. into a glass disk using 20 MPa of applied pressure. The glass disk was then machined into 0.7 mm thick disks about 6 mm in diameter which were then polished to an optically smooth surface. Multiple disks were prepared by repeating the procedure. Several glass disks were subsequently heat-treated in a vacuum furnace (“PRO PRESS 100”) at 915° C. for 30 minutes, followed by an additional treatment at 920° C. for 30 minutes.

Vickers indentation experiments were conducted on glass disks before and after heat-treatment in accordance with the procedure described above. It was observed that after heat-treatment the length of Vickers cracks drastically decreased indicating significant toughening of the material.

The a biaxial flexural strength of material heat-treated at 930° C. and 940° C. were measured as described above in Example 1, except that glass-ceramic disks were prepared form the consolidated microbead glass disks of this Example, and found to be 715 MPa and 610 MPa, respectively.

The optical translucency of the material heat-treated at 930° C. was measured as described in Example 1, and found to be 85%.

Foreseeable modifications and alterations of this disclosure will be apparent to those skilled in the art without departing from the scope and spirit of this invention. This invention should not be restricted to the embodiments that are set forth in this application for illustrative purposes.

1. A glass-ceramic comprising at least 20 by weight alumina and at least 15 percent by weight collectively of rare earth oxide, yttrium oxide, and alkaline earth oxide, based on the total weight of the glass-ceramic, wherein the rare earth is selected from the group consisting of La, Ce, Pr, Nd, Sm, Eu, Gd, and combinations thereof, wherein the alkaline earth oxide is selected from the group consisting of BaO, CaO, SrO, MgO, and combinations thereof, wherein the molar ratio of the alumina to the collective rare earth oxide, yttrium oxide, and alkaline earth oxide is up to 3.2, and wherein the glass-ceramic has an average hardness in a range from 8 GPa to 12 GPa and an average flexural strength of at least 500.

2. The glass-ceramic of claim 1, wherein at least a portion of the alumina and rare earth oxide are present as at least 20 percent by volume of ReAlO₃, based on the total volume of the glass-ceramic, and wherein Re is selected from the group consisting of La, Ce, Pr, Nd, Sm, Eu, Gd, and combinations thereof.

3. The glass-ceramic of claim 1 that is optically translucent.

4. The glass-ceramic of claim 1 further comprising at least 5 percent by weight collectively of at least one of zirconia or hafnia, based on the total weight of the glass-ceramic, wherein the molar ratio of alumina to the collective rare earth oxide, yttrium oxide, and alkaline earth oxide is up to 3.

5. The glass-ceramic of claim 1, wherein the glass-ceramic is a dental article.

6. A method of making the glass-ceramic of claim 1, the method comprising heat-treating a glass having a Tₓ and the glass comprising at least 20 percent by weight alumina and at least 15 percent by weight collectively of rare earth oxide, yttrium oxide, and alkaline earth oxide, based on the total weight of the glass-ceramic, wherein the rare earth is selected from the group consisting of La, Ce, Pr, Nd, Sm, Eu, Gd, and combinations thereof, wherein the alkaline earth oxide is selected from the group consisting of BaO, CaO, SrO, MgO, and combinations thereof, wherein the molar ratio of the alumina to the collective rare earth oxide, yttrium oxide, and alkaline earth oxide is up to 3.2, to provide the glass-ceramic.

7. A glass-ceramic comprising at least 20 percent by weight alumina and at least 15 percent by weight rare earth oxide, based on the total weight of the glass-ceramic, wherein the rare earth is selected from the group consisting of La, Ce, Pr, Nd, Sm, Eu, Gd, and combinations thereof, wherein the molar ratio of alumina to rare earth oxide is up to 3.2, wherein at least a portion of the alumina and rare earth oxide are present as at least 30 percent by volume of ReAlO₃, wherein Re is selected from the group consisting of La, Ce, Pr, Nd, Sm, Eu, Gd, and combinations thereof, and wherein the glass-ceramic has an average flexural strength of at least 1.5 GPa.

8. The glass-ceramic of claim 7, wherein the glass-ceramic has an average hardness in a range from 8 GPa to 12 GPa.

9. The glass-ceramic of claim 7 further comprising at least 5 percent by weight collectively of at least one of zirconia or hafnia, based on the total weight of the glass-ceramic, wherein the molar ratio of alumina to rare earth oxide is up to 3.

10. The glass-ceramic of claim 7, wherein the glass-ceramic is a dental article.

11. A method of making the glass-ceramic of claim 7, the method comprising heat-treating a glass having a Tₓ and the glass comprising at least 20 percent by weight alumina and at least 15 by weight rare earth oxide, based on the total weight of the glass, wherein the rare earth is selected from the group consisting of La, Ce, Pr, Nd, Sm, Eu, Gd, and combinations thereof, wherein the molar ratio of alumina to rare earth oxide is up to 3.2, wherein at least a portion of the alumina and rare earth oxide are present as at least 30 percent by volume of ReAlO₃, and wherein Re is selected from the group consisting of La, Ce, Pr, Nd, Sm, Eu, Gd, and combinations thereof, to provide the glass-ceramic.

12. The glass-ceramic of claim 1, wherein the glass-ceramic collectively comprises at least 60 percent of alumina, collectively rare earth oxide and yttrium oxide, and alkaline earth oxide selected from the group consisting of BaO, CaO, SrO, MgO, and combinations thereof, based on the total weight of the glass.

13. A method of making one of a dental article or an orthodontic appliance comprising:
providing a glass having a T_{g} and Tₓ, and the glass comprising at least 20 percent by weight alumina and at least 15 percent by weight collectively of rare earth oxide, yttrium oxide, and alkaline earth oxide, based on the total weight of the glass-ceramic, wherein the rare earth is selected from the group consisting of La, Ce, Pr, Nd, Sm, Eu, Gd, and combinations thereof, wherein the alkaline earth oxide is selected from the group consisting of BaO, CaO, SrO, MgO, and combinations thereof, wherein the molar ratio of the alumina to the collective rare earth oxide, yttrium oxide, and alkaline earth oxide is up to 3.2;
heating the glass above the T_{g} such that the glass deforms to form one of a dental article or an orthodontic appliance having a shape;
optionally cooling the shaped glass article; and
heat-treating the glass article in a range from 800° C. to 1050° C. to convert at least a portion of the glass to glass-ceramic of claim 1.

14. A method of making one of a dental article or an orthodontic appliance comprising:
providing one of a dental mill blank or an orthodontic mill blank comprising a glass having a T_{g} and Tₓ, and the glass comprising 20 percent by weight alumina and at least 15 percent by weight collectively of rare earth oxide, yttrium oxide, and alkaline earth oxide, based on the total weight of the glass, wherein the rare earth is selected from the group consisting of La, Ce, Pr, Nd, Sm, Eu, Gd, and combinations thereof, wherein the alkaline earth oxide is selected from the group consisting of BaO, CaO, SrO, MgO, and combinations thereof, wherein the molar ratio of the alumina to the collective rare earth oxide, yttrium oxide, and alkaline earth oxide is up to 3.2;
carving the dental mill blank or orthodontic mill blank to provide the dental article or orthodontic appliance; and
heat-treating the glass in a range from 800° C. to 950° C. to convert at least a portion of the glass to glass-ceramic of claim 1.

15. The glass-ceramic of claim 7, wherein the glass-ceramic collectively comprises at least 60 percent of the alumina and the rare earth oxide, based on the total weight of the glass-ceramic.

16. The glass-ceramic of claim 7, further comprising at least one of niobium oxide, tantalum oxide, titanium oxide, lithium oxide, potassium oxide, or sodium oxide.

17. A method of making one of a dental article or an orthodontic appliance comprising:
providing a glass having a T_{g} and Tₓ, and the glass comprising at least 20 (in some embodiments, at least 25, 30, 35, 40, 45, 50, or even at least 55; in some embodiments, in a range from 20 to 60, 25 to 60, 30 to 60, 35 to 60, 40 to 60; or even 25 to 45) percent by weight alumina and at least 15 percent by weight rare earth oxide, based on the total weight of the glass, wherein the rare earth is selected from the group consisting of La, Ce, Pr, Nd, Sm, Eu, Gd, and combinations thereof, wherein the molar ratio of alumina to rare earth oxide is up to 3.2, wherein at least a portion of the alumina and rare earth oxide are present as at least 30 percent by volume of ReAlO₃, and wherein Re is selected from the group consisting of La, Ce, Pr, Nd, Sm, Eu, Gd, and combinations thereof;
heating the glass above the T_{g} such that the glass deforms to form one of a dental article or an orthodontic appliance having a shape;
optionally cooling the shaped glass article; and
heat-treating the glass article in a range from 800° C. to 1050° C. to convert at least a portion of the glass to glass-ceramic of claim 7.

18. A method of making one of a dental article or an orthodontic appliance comprising:
providing one of a dental mill blank or an orthodontic mill blank comprising a glass having a T_{g} and Tₓ, and the glass comprising at least 20 percent by weight alumina and at least 15 percent by weight rare earth oxide, based on the total weight of the glass, wherein the rare earth is selected from the group consisting of La, Ce, Pr, Nd, Sm, Eu, Gd, and combinations thereof, wherein the molar ratio of alumina to rare earth oxide is up to 3.2, wherein at least a portion of the alumina and rare earth oxide are present as at least 30 percent by volume of ReAlO₃, and wherein Re is selected from the group consisting of La, Ce, Pr, Nd, Sm, Eu, Gd, and combinations thereof;
carving the dental mill blank or orthodontic mill blank to provide the dental article or orthodontic appliance; and
heat-treating the glass in a range from 800° C. to 950° C. to convert at least a portion of the glass to glass-ceramic of claim 7.
